(19) United States
(12) Patent Application Publication
(10) Pub. No.: US 2026/0194407 A1
(43) Pub. Date: Jul. 9, 2026

(54) PRESSURE SENSOR, PRESSURE SENSOR ARRANGEMENT AND USE OF THE PRESSURE SENSOR

(71) Applicant: Kistler Holding AG, Winterthur (CH)

(72) Inventors: Giovanni Mastrogiacomo, Zuerich (CH); Davide Aloi, Elgg (CH); Urs Pfister, Winterthur (CH); Thomas Cadonau, Kirchberg (CH)

(21) Appl. No.: 18/863,851

(22) PCT Filed: Apr. 5, 2023
(86) PCT No.: PCT/EP2023/059000

§ 371 Date: Nov. 7, 2024

(30) Foreign Application Priority Data
May 11, 2022 (EP) 22172688.8

(51) Int. Cl. G01L 19/14; G01L 9/00

(52) U.S. Cl. CPC G01L 19/14; G01L 9/008

(57) ABSTRACT

A pressure sensor includes a sensor housing that defines a chamber, a measuring element within the chamber, and a diaphragm that closes the chamber at a front end of the sensor housing. An accommodating body is spaced apart from the front end and configured to be inserted into a bore of a mounting body. The front end defines a sealing element configured at least locally conically on its outside for sealing the sensor housing in the bore.

### CROSS-REFERENCE TO RELATED APPLICATION

The present application is related by subject matter to commonly owned U.S. application Ser. No. 18/529,053, filed on Dec. 5, 2023, and published as publication No. 2024-0192073, which is hereby incorporated herein in its entirety by this reference for all purposes.

### TECHNICAL FIELD OF THE INVENTION

The invention relates to a pressure sensor, a pressure sensor arrangement including a pressure sensor and a mounting body as well as to the use of the pressure sensor and the pressure sensor arrangement, respectively, in particular in the context of measuring the pressure of hydrogen.

### BACKGROUND OF THE INVENTION

EP1146326A2 discloses a pressure sensor having the features according to the preamble of claim 1. The known pressure sensor is arranged in a bore of a mounting body, which bore communicates with a supply bore to which the pressure of a medium is applied, wherein the pressure acts onto a diaphragm positioned in a chamber of a sensor housing of the pressure sensor. The diaphragm itself is operatively connected to a measuring or sensor element arranged in the interior of the sensor housing and detecting a deformation of the diaphragm to deduce the amount of pressure of the medium therefrom. In one embodiment of the pressure sensor and the pressure sensor arrangement, respectively, there may be provided a pressure sensor that is connected to the bore via an axially interposed separate sealing element locally having a conical shape in such a way that the sealing element enables sealing of the bore and the pressure sensor, respectively, to prevent medium from leaking from the mounting body. With respect to the axial extension of the sensor housing, the diaphragm is arranged approximately centrally, i.e. the medium must first pass through the sensor housing into the chamber to be able to act onto the diaphragm.

For a medium that contains hydrogen, the pressure sensor must both be impermeable for and resistant to hydrogen. The reason is that with a sensor housing and a diaphragm made of metallic material, hydrogen may penetrate into the material and cause corrosion of the material which may lead to hydrogen-related cracking with brittle fractures and failure of the pressure sensor. Furthermore, hydrogen that has penetrated may also chemically react with the measuring or sensor element arranged inside the sensor housing and may impair the functionality of the sensor element.

### OBJECTS AND SUMMARY OF THE INVENTION

The pressure sensor of the present invention having the features described more fully below comprises a sensor housing that is made particularly compact in terms of its overall axial length and makes it possible to detect the pressure of a medium directly or in an area of the bore of the mounting body that is located in the proximity of a supply portion for the medium. The bore is made as short as possible in its axial extension. The sensor housing comprises a front side end in the area of the bore, which front side end defines a diaphragm. This enables a very precise pressure measurement. The reason is that the pressure in the bore is altered when the length of the bore increases, and such alteration may falsify the pressure measurement. In this way, it is further not necessary to provide a means for supplying medium up to the area of the diaphragm in the form of a bore or in a chamber, respectively, within the sensor housing. Instead, the interior of the sensor housing need only serve for accommodating the measuring or sensor element.

To achieve the advantages mentioned above, the invention provides that the sealing element is arranged at a distance from the front side end in the area of the sensor housing where the sensor housing protrudes from the accommodating body and into the bore. In contrast to the prior art, the pressure sensor is sealed within the bore so that no medium can reach the accommodating body. In particular in the case of a medium that contains hydrogen, the hydrogen is not able to reach the accommodating body at all. Therefore, it is not necessary to fabricate the accommodating body from a material that is resistant to hydrogen so that the manufacture of the pressure sensor is cost-effective. In the following, a medium that contains hydrogen is understood to mean a hydrogen-containing fluid medium that contains at least one percent by volume of hydrogen.

Advantageous further developments of the pressure sensor according to the invention are indicated in the following description.

In a presently preferred further development of the pressure sensor, the sensor housing comprises a conical sensor housing portion in an area that faces away from the front side in the direction of the accommodating body; wherein the sealing element is arranged in the conical sensor housing portion.

Thus, the pressure sensor is sealed in the bore between the sensor housing and the mounting body. In this way, a medium that contains hydrogen can only penetrate up to the front side end and to the conical sensor housing portion of the sensor housing.

In another presently preferred further development of the pressure sensor, the sensor housing is fashioned out of a single workpiece from the front side up to and including the conical sensor housing portion.

The region of the sensor housing that comes into contact with a hydrogen-containing medium is made of one piece, which facilitates cost-effective manufacture and avoids operations that form a connection of materials such as a weld seam that comes into contact with the hydrogen-containing medium and thereby might cause premature aging of the connection of materials. Thus, the front side up to and including the conical sensor housing portion is formed of one piece.

In a first presently preferred embodiment of the pressure sensor in which in contrast to the prior art mentioned above a separate sealing element can be omitted there is provided a sealing element formed by a monolithically with the conical sensor housing portion. In this way, a particularly simple construction of the pressure sensor is achieved that requires few components making it cost-effective.

An alternative embodiment may provide that the sealing element is formed by a component separate from the sensor housing and connected to the sensor housing by a conically shaped form-fitting connection. By using a sealing element that is separate from the sensor housing, the materials of the sealing element and the sensor housing may be chosen to be optimally adapted to the respective intended use so that on the one hand the sealing effect of the sealing element is optimized and on the other hand a material that can be processed particularly easily and cost-effectively, for example, is used for manufacturing the sensor housing.

A presently preferred further development of the suggestion mentioned above provides that the sealing element is shaped in the form of an annulus, and the sensor housing comprises a conically shaped accommodation for positioning the sealing element wherein the accommodation forms a stop surface for the sealing element against a mounting direction of the pressure sensor into the bore of the mounting body, and wherein the sealing element and the sensor housing are made of the same or of different materials.

In particular in a case where the sensor housing, the accommodating body and the mounting body have the same or not greatly different coefficients of thermal expansion, there may be provided a sensor housing that is directly connected to the accommodating body.

To compensate for different coefficients of thermal expansion of the components mentioned, there may also be provided a sensor housing that is connected to the accommodating body via an interposed, preferably annularly shaped, heat compensation element wherein the material of the sensor housing and the material of the accommodating body have different coefficients of thermal expansion.

Securing of the accommodating body in the mounting body is preferably realized by forming the securing area on the accommodating body in the form of an external thread on the accommodating body. This external thread engages a matching internal thread made in the bore of the mounting body so that by screwing the accommodating body into the bore or into the internal thread of the mounting body, respectively, the required sealing force for sealing the accommodating body or the sensor housing is achieved.

Another presently preferred structural embodiment of the sensor housing for achieving the highest possible sensitivity of the measuring element provides that the sensor housing is formed rotationally symmetrically with respect to a longitudinal axis and that radially outside of a connecting area to the measuring element the diaphragm comprises an annularly shaped weakened area, in which area the wall thickness of the diaphragm is reduced compared to the connecting area.

Moreover, to achieve an approach for mounting the accommodating body or the pressure sensor, respectively, in the mounting body that is as simple as possible and reproducible regarding the generation of the sealing force, there is provided an accommodating body that comprises a tool engagement surface for connecting the pressure sensor to the mounting body. In this way, it is possible to use a threaded connection and to generate the required sealing force by means of a defined tightening torque of the accommodating body in the bore of the mounting body.

Furthermore, the invention also encompasses a pressure sensor arrangement comprising a pressure sensor according to the invention as described above and a mounting body comprising a bore for securing the accommodating body of the pressure sensor.

A presently preferred structural embodiment of the pressure sensor arrangement for achieving the desired sealing force provides that the bore comprises a supply portion for the medium that, on the side facing the pressure sensor, is followed by a conically shaped mounting body portion, and that the conically shaped mounting body portion has a first opening angle that is greater than a second opening angle of the sensor housing or the sealing element, respectively, in a contact zone between the bore in the mounting body and the sensor housing or the sealing element, respectively.

A further development of the geometry described in the paragraph above provides that in the transition area between the supply portion and the conically shaped mounting body portion the sealing element rests against the bore in the area of the annularly shaped contact zone. This ensures that regardless of the tolerances of the two opening angles in the area of the bore and the sensor housing or the sealing element, respectively, the elements mentioned are always positioned in the same location.

Finally, the invention also encompasses the use of a pressure sensor or a corresponding pressure sensor arrangement according to the invention for detecting a pressure of hydrogen.

### BRIEF DESCRIPTION OF THE DRAWINGS

Further advantages, features and details of the invention will become apparent from the following description of preferred embodiments of the invention and referring to the drawings in which:

FIG. 1 shows an area of a pressure sensor arrangement for measuring the pressure of hydrogen in longitudinal section;

FIG. 2 shows a detail of FIG. 1 in an enlarged view;

FIG. 3 shows a front side end region of a sensor housing of the pressure sensor according to FIGS. 1 and 2 in longitudinal section;

FIG. 4 shows a sensor housing that is modified from to FIG. 3 also in longitudinal section; and

FIG. 5 shows a pressure sensor that is modified from the representations according to FIGS. 1 and 2 to compensate for different coefficients of thermal expansion of the components of the pressure sensor arrangement in longitudinal section.

Throughout the figures, like elements or elements having the same function are designated with the same reference numerals.

### DETAILED DESCRIPTION OF EXEMPLARY EMBODIMENTS OF THE INVENTION

FIG. 1 shows a cross-section taken along a symmetrical longitudinal axis 105 of a pressure sensor arrangement 100 for measuring the pressure of an exemplary gaseous medium, in particular of hydrogen. The pressure sensor arrangement 100 comprises a mounting body 102 that is designed to contain an interior space, which is accessible via a channel defined by a supply portion 106 and which is subject to pressure changes within the interior space. The mounting body defines a stepped bore 104 that is configured with a plurality of portions for receiving a pressure sensor 10 and characterized by changes in diameter measured normal to the longitudinal axis 105. The bore 104 desirably is configured symmetrically with respect to the longitudinal axis 105. The bore 104 extends along the longitudinal axis 105 and is defined by a (cylindrically shaped) supply portion 106 in which the pressure of the medium (hydrogen) acts. The supply portion 106 is followed by a conical mounting body portion 107 having a first opening angle α₁ diverging symmetrically about the longitudinal axis 105. From the conical mounting body portion 107 extends a base portion 108 in a direction perpendicular to the longitudinal axis 105 and followed along the longitudinal axis 105 by a threaded portion 109 of the mounting body 102 where an internal screw thread 110 is formed.

As schematically in cross-section in FIG. 1, the pressure sensor 10 comprises an accommodating body 12 that is configured concentrically with respect to the longitudinal axis 105 and comprises a cylindrical portion 14 comprising an external thread 16 that serves as a mounting portion and engages, desirably in a rotatable screw relationship, the internal thread 110 of the threaded portion 109 for securing the accommodating body 12 within the bore 104 of the mounting body 102. Outside the cylindrical portion 14 and outside the bore 104, respectively, the accommodating body 12 comprises a mounting portion 18 with an enlarged diameter measured perpendicularly to the longitudinal axis 105. The mounting portion 18 includes an outer surface 20 that defines a tool engagement surface 20 that is configured for interacting with a tool (not shown), in particular with an open-end wrench or a torque wrench. The accommodating body 12 and, thus, the pressure sensor 10 can be screwed or secured in the bore 104 of the mounting body 102 by means of the tool engagement surface 20.

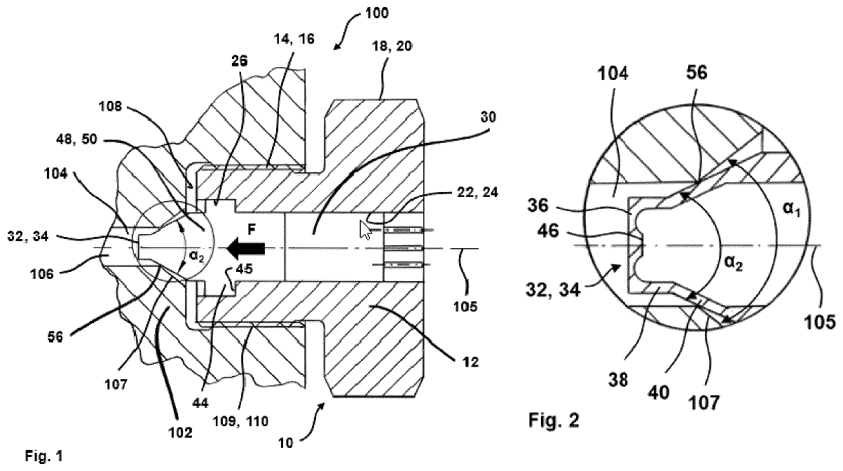

Furthermore, the accommodating body 12 defines a through bore 22 that is concentric to the longitudinal axis 105 and comprises a first portion 24 defined by a first diameter measured normal to the longitudinal axis. The first portion opens through a back end of the accommodating body 12 and defines a surface generally parallel to the outer surface 20 of the mounting portion 18. The through bore of the accommodating body 12 is defined by a second portion 26 having an enlarged internal diameter measured perpendicularly to the longitudinal axis 105 as compared to the internal diameter of the first portion 24 of the through bore 22. The through bore 22 serves to accommodate a sensor housing 30 that locally protrudes from the accommodating body 12 along the longitudinal axis 105 and includes a front side end region 32, which extends up to the supply portion 106 of the bore 104 when the pressure sensor 10 is installed into the mounting body 102 as shown in FIGS. 1 to 2. As shown in FIG. 1, the front side end region 32 defines one end of the sensor housing 30 that faces away from the back end of the accommodating body 12 and ends in a front side 34 of the sensor housing 30. The front side end region 32 defines a diaphragm 36 (FIG. 2).

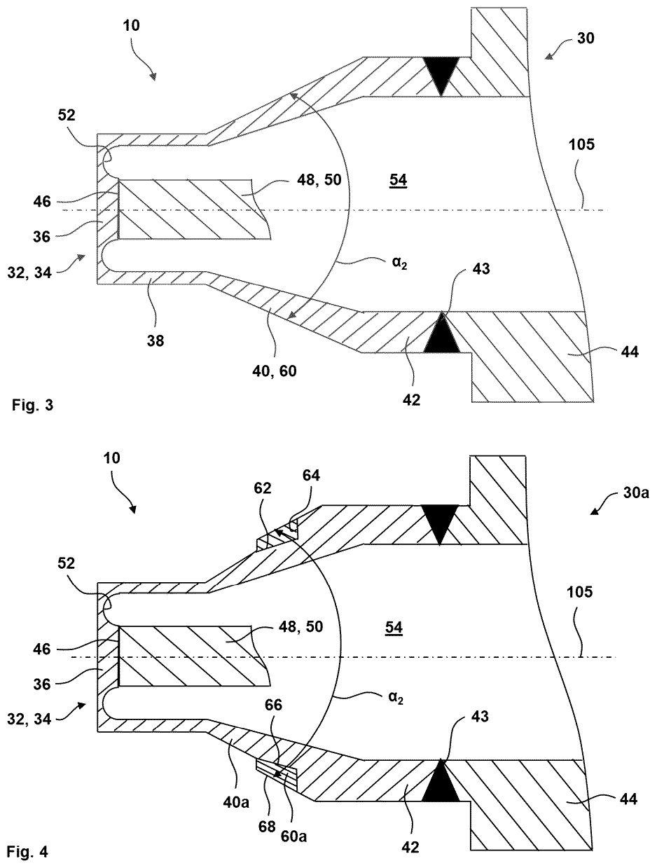

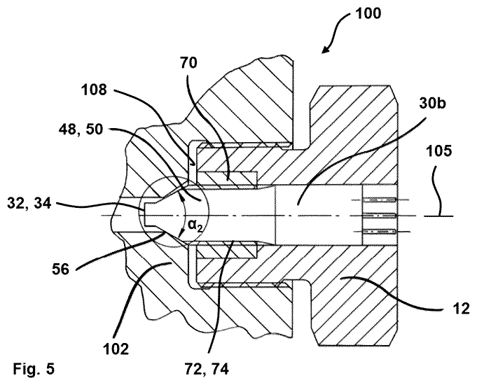

Extending along the longitudinal axis 105 from the front side end region 32, the sensor housing 30 (FIG. 3), 30a (FIG. 4) is defined by successively contiguous regions 38, 40, 42 and 44. In a region that leads away from the front side 34 and in the direction toward the back end of the accommodating body 12, the sensor housing 30 is formed to define a first hollow cylindrical portion 38 schematically shown in FIG. 2 which is an enlarged section of FIG. 1. Contiguous with the hollow cylindrical portion 38 is a conical sensor housing portion 40. The sensor housing 30; 30a; desirably is made of one piece from the front side 34 up to and including the conical sensor housing portion designated 40; 40a respectively in FIGS. 3 and 4. With its outer surface, the conical sensor housing portion 40 spans to diverge at a second opening angle α₂, which second opening angle α₂ is smaller than a first opening angle α₁ shown schematically in FIG. 2 defined by the diverging internal surface of the conical mounting body portion 107 of the bore 104. Thus, the second opening angle α₂ is smaller than the first opening angle α₁ by an angle of at least 1°, for example.

Also, as shown in FIGS. 3 and 4, in the direction of the accommodating body 12, the conical sensor housing portion 40 is followed contiguously by a second hollow cylindrical portion 42 (FIG. 3) of the sensor housing 30. And further in the direction of the accommodating body 12, the second hollow cylindrical portion 42 is followed contiguously by a hollow cylindrical sensor housing portion 44 (FIGS. 1, 3 and 4) with further enlarged external diameter measured perpendicularly to the longitudinal axis 105. As shown in FIG. 1, the hollow cylindrical sensor housing portion 44 desirably is configured to enter the second portion 26 of the through bore 22 of the accommodating body 12 to act as a stop surface 45 for the sensor housing 30 in the direction of the accommodating body 12.

As shown in FIGS. 3 and 4, a connection of materials 43 is formed between the material of the sensor housing 30; 30a; 30b and the hollow cylindrical sensor housing portion 44 in a region that faces away from the conical sensor housing portion 40; 40a in the direction of the accommodating body 12. Thus, the second hollow cylindrical portion 42 and the hollow cylindrical sensor housing portion 44 are mechanically connected to each other by a connection of materials 43 such as a weld seam.

It is apparent in particular from FIGS. 2 and 3 for example that the diaphragm 36 is defined in part by a central connecting section 46 that is configured for securing a measuring element 48, in particular in the form of a piezo element 50 as shown in FIGS. 3 and 4. The piezo element 50 may operate according to the piezoresistive or the piezoelectric measuring principle. The measuring element 48 or the piezo element 50, respectively, is connected to the diaphragm 36 in a conventional manner known per se so that a deformation of the diaphragm 36 leads to the generation of an equivalent signal at and by the measuring element 48.

Radially outside of the connecting section 46, between the measuring element 48 and the diaphragm 36, the diaphragm 36 is defined as an annularly shaped elastic region 52 shown in FIGS. 3 and 4. The annularly shaped elastic region 52 is disposed about the longitudinal axis 105 and forms an annular section in which the wall thickness of the diaphragm 36 measured parallel to the longitudinal axis 105 is reduced when viewed from the side of a chamber 54 that is intended and configured as an accommodating space for the measuring element 48.

To insert the pressure sensor 10 in the bore 104 of the mounting body 102 in a sealing manner and thereby prevent the medium from leaking from the mounting body 102, a mounting force F schematically depicted in FIG. 1 as a thickened arrow is generated via the accommodating body 12 and the threaded connection between the accommodating body 12 and the mounting body 102 that acts in the direction toward the supply bore 106. In the transition area between the supply bore 106 and the conical mounting body portion 107, the mounting force F causes the sensor housing 30 to seal tightly with its conical sensor housing portion 40 in an annularly shaped contact zone 56 that is schematically indicated in FIGS. 1 and 2 and extends circumferentially about the longitudinal axis 105. The contact zone 56 is located in front of the accommodating body 12 with respect to the longitudinal axis 105 so that no medium can penetrate up to the accommodating body 12. Thus, in the region of its conical sensor housing portion 40, the sensor housing 30 also forms a sealing element 60 schematically indicated in FIG. 3.

As represented in FIG. 4, instead of a sealing element 60 formed monolithically by the conical sensor housing portion 40, it is also possible to provide the use of a modified sensor housing 30a comprising, in the conical sensor housing portion 40a, a conical accommodation 62 extending in the form of a ring-shaped undercut defined circumferentially about the longitudinal axis 105 and defining a stop surface 64 that desirably extends perpendicular to the longitudinal axis 105. The conical accommodation 62 is configured to accommodate a sealing element 60a fabricated as a separate component in the form of a sealing ring 66 consisting of the same or of a different material than the material forming the conical sensor housing portion 40. By using a sealing element 60a made of the same material as the sensor housing 30a it is possible to avoid different coefficients of thermal expansion in the region of the contact zone 56. Using a sealing element 60a that is made of a softer material than the sensor housing 30a has the advantage that the tightening torque required for sealing the contact zone 56 is relatively small so that the serviceable life of the pressure sensor 10 is increased since the tightening torque applied to the pressure sensor 10 for sealing is small. In the axial direction opposite to the mounting direction of the accommodating body 12 into the bore 104 of the mounting body 102, the sealing element 60a interacts with the stop surface 64 whereby the required sealing force is generated also in the area of the bore 104 via the sensor housing 30a.

As in the case of the conical sensor housing portion 40a, the sealing element 60a or the sealing ring 66, respectively, also has a conical circumferential outer surface 68 spanning the second opening angle α₂ and serving as a sealing surface. The amount of the second opening angle α₂ in the embodiment according to FIG. 4 may differ from the amount of the second opening angle α₂ in the embodiment according to FIG. 3. However, also in the embodiment of the pressure sensor 10 according to FIG. 4, the contact zone 56 is located in front of the accommodating body 12 with respect to the longitudinal axis 105 so that no medium can penetrate up to the accommodating body 12.

In the embodiment of the pressure sensor 10 as represented in FIGS. 1 to 4, the sensor housing 30, 30a is directly connected to the accommodating body 12. This is always advantageous in situations where the materials of the accommodating body 12, the sensor housing 30, 30a and the mounting body 102 have at least approximately the same coefficients of thermal expansion that differ from each other by no more than 10%, for example. However, as shown in FIG. 5, to ensure the required impermeability under all operating conditions or pressures and temperatures also in the case of coefficients of thermal expansion that significantly differ from each other, it may be provided that a sensor housing 30b is connected to the accommodating body 12 by radially interposing cylindrically shaped heat compensation element 70. The heat compensation element 70 comprises for example an internal thread 72 that interacts with an external thread 74 formed on the sensor housing 30b for this purpose. In this case it is advantageous when differently handed threads are used for the external thread 72 on the heat compensation element 70 and on the external thread 16 of the accommodating body 12 to prevent loosening of the heat compensation element 70 into the accommodating body 12 when the accommodating body 12 is screwed into the threaded portion 109 of the mounting body 102.

The pressure sensor 10 and the pressure sensor arrangement 100, respectively, described hereinbefore may be subjected to variation and modification in many ways without deviating from the idea underlying the invention.

### LIST OF REFERENCE NUMERALS

10 pressure sensor
12 accommodating body
14 cylindrical portion
16 external thread
18 mounting portion
20 tool engagement surface
22 through bore
24 first portion
26 second portion
30 sensor housing
30a, 30b sensor housing
32 front side end
34 front side
36 diaphragm
38 first hollow cylindrical portion
40,40a conical sensor housing portion
42 second hollow cylindrical portion
43 connection of materials
44 hollow cylindrical sensor housing portion
45 stop surface of hollow cylindrical sensor housing portion
46 connecting area
48 measuring element
50 piezo element
52 elastic region
54 chamber
56 contact zone
60, 60a sealing element
62 accommodation
64 stop surface
66 sealing ring
68 outer surface
70 heat compensation element
72 internal thread
74 external thread
100 pressure sensor arrangement
102 mounting body
104 bore
105 longitudinal axis
106 supply portion
107 conical mounting body portion
108 base portion
109 threaded portion
110 internal thread
F mounting force
α₁ 1^{st} opening angle
α₂ 2^{nd} opening angle

1. (canceled)

2. The pressure sensor according to claim 15, wherein the outer surface of the sensor housing defines a conical sensor housing portion that diverges away from the diaphragm in the direction of the accommodating body; and wherein the sealing element is arranged in the conical sensor housing portion.

3. The pressure sensor according to claim 2, the sensor housing is made of one piece from the diaphragm up to and including the conical sensor housing portion.

4. The pressure sensor according to claim 2, further comprising a hollow cylindrical housing portion that faces away from the conical sensor housing portion in the direction of the accommodating body and includes a connection of materials between the sensor housing and the hollow cylindrical sensor housing portion.

5. The pressure sensor according to claim 2, wherein the sealing element is formed monolithically with the conical sensor housing portion.

6. The pressure sensor according to claim 15, wherein the sealing element is formed by a component separate from the sensor housing and connected to the sensor housing by a conically shaped form-fitting connection.

7. The pressure sensor according to claim 6, wherein the sealing element is designed as a sealing ring and the sensor housing comprises a conical accommodation for positioning the sealing element, wherein the accommodation forms a stop surface (64) for the sealing element, and wherein the sealing element and the sensor housing are made of the same materials.

8. The pressure sensor according to claim 15, wherein the sensor housing is directly connected to the accommodating body.

9. The pressure sensor according to claim 15, wherein the sensor housing is connected to the accommodating body via an interposed, annular, heat compensation element, wherein the material of the sensor housing and the material of the accommodating body have different coefficients of thermal expansion.

10. The pressure sensor according to claim 15, wherein the accommodating body defines a tool engagement surface that connects the pressure sensor to the mounting body.

11. A pressure sensor arrangement comprising:
a mounting body that defines a bore containing an interior space for housing a medium subject to pressure changes;
a sensor housing defining a front side end and a back side end spaced apart along a longitudinal axis from the front side end, wherein the sensor housing defines a chamber that is hollow and disposed between the front side end and the back side end, wherein the front side end defines a diaphragm that closes the chamber at the front side end of the sensor housing;
a measuring element disposed in the chamber of the sensor housing in operative connection with the diaphragm for detecting a pressure-dependent deformation of the diaphragm;
an accommodating body connected to the back side end of the sensor housing and configured to be inserted into the bore of the mounting body and connected to the bore of the mounting body by means of a mounting portion defined on an external surface of the accommodating body:
a sealing element configured for sealing the sensor housing in the bore of the mounting body, wherein the sealing element defines an external surface that is conical in shape, wherein the sealing element defines an internal surface that is connected to an outer surface of the sensor housing, wherein the outer surface of the sensor housing is disposed between the front side end and the back side end of the sensor housing.

12. The pressure sensor arrangement according to claim 11, wherein the bore is defined by a supply portion configured for conducting the medium to the diaphragm and contiguous with a conical mounting body portion that is disposed closer to the sensor housing, and wherein the conical mounting body portion spans a first opening angle that is greater than a second opening angle of the sensor housing in a contact zone between the bore in the mounting body and the sensor housing.

13. The pressure sensor arrangement according to claim 12, the sealing element rests against the bore in a region where the supply portion of the bore becomes contiguous with the conical mounting body portion of the bore.

14. (canceled)

15. A pressure sensor for disposition into a bore of a mounting body containing an interior space subject to pressure changes, the pressure sensor comprising:
a sensor housing defining a front side end and a back side end spaced apart along a longitudinal axis from the front side end, wherein the sensor housing defines a chamber that is hollow and disposed between the front side end and the back side end, wherein the front side end defines a diaphragm that closes the chamber at the front side end of the sensor housing;
a measuring element disposed in the chamber of the sensor housing in operative connection with the diaphragm for detecting a pressure-dependent deformation of the diaphragm;
an accommodating body connected to the back side end of the sensor housing and configured to be inserted into the bore of the mounting body and connected to the bore of the mounting body by means of a mounting portion defined on an external surface of the accommodating body; and
a sealing element configured for sealing the sensor housing in the bore of the mounting body, wherein the sealing element defines an external surface that is conical in shape, wherein the sealing element defines an internal surface that is connected to an outer surface of the sensor housing, wherein the outer surface of the sensor housing is disposed between the front side end and the back side end of the sensor housing.

16. The pressure sensor according to claim 15, further comprising a heat compensation element interposed between the sensor housing and the accommodating body and connecting the sensor housing to the accommodating body.

17. The pressure sensor according to claim 16, wherein the sensor housing defines an external thread, the heat compensation element defines an internal thread configured to connect to the external thread of the sensor housing, wherein the accommodating body defines an inner thread, wherein the heat compensation element defines an outer thread configured to connect to the inner thread of the accommodating body, and wherein the outer thread of the heat compensation element and the internal thread of the heat compensation element are defined with opposite-handed configurations.

18. The pressure sensor according to claim 6, wherein the sealing element is designed as a sealing ring and the sensor housing comprises a conical accommodation for positioning the sealing element, wherein the accommodation forms a stop surface for the sealing element, and wherein the sealing element and the sensor housing are made of different materials.

19. The pressure sensor arrangement according to claim 11, wherein the bore is defined by a supply portion configured for housing the medium and contiguous with a conical mounting body portion that is disposed closer to the sensor housing, and wherein the conical mounting body portion spans a first opening angle that is greater than a second opening angle of the sealing element in a contact zone between the bore in the mounting body and the sealing element.
